(19) United States
(12) Patent Application Publication
(10) Pub. No.: US 2020/0095874 A1
(43) Pub. Date: Mar. 26, 2020

(54) TURBINE WHEEL ASSEMBLY WITH PLATFORM RETENTION FEATURES

(71) Applicants: Rolls-Royce North American Technologies Inc., Indianapolis, IN (US); Rolls-Royce Corporation, Indianapolis, IN (US); Rolls-Royce plc, London (GB)

(72) Inventors: Ted J. Freeman, Danville, IN (US); Aaron D. Sippel, Zionsville, IN (US); Anthony Razzell, Derbyshire (GB)

(21) Appl. No.: 16/142,850

(22) Filed: Sep. 26, 2018

(51) Int. Cl. F01D 5/30

(52) U.S. Cl. CPC F01D 5/3015; F05D 2250/72; F05D 2230/60; F05D 2220/3215

(57) ABSTRACT

A wheel assembly for a gas turbine engine includes a disk, a plurality of blades, and a platform system. The disk is configured to rotate about an axis during operation of the gas turbine engine. The blades are coupled with the disk for rotation therewith. The platform system includes a plurality of platforms arranged around the blades and a coverplate that blocks movement of the platforms relative to the disk.

### FIELD OF THE DISCLOSURE

The present disclosure relates generally to gas turbine engines, and more specifically to wheel assemblies for use in gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

To withstand heat from the combustion products received from the combustor, the turbine may include turbine wheels having blades that comprise composite materials adapted to interact with the hot combustion products. In some turbine wheels, the blades may be coupled to a disk that supports the blades in a gas path of the engine. Coupling the composite blades with disks can present design challenges.

### SUMMARY

The present disclosure may comprise one or more of the following features and combinations thereof.

A wheel assembly for a gas turbine engine may include a disk, a plurality of blades, and a platform system. The disk may be adapted to rotate about an axis during use of the gas turbine engine. The plurality of blades may be adapted to interact with gases during use of the gas turbine engine. Each of the plurality of blades may include a root coupled with the disk for rotation therewith and an airfoil that extends radially away from the root.

The platform system may be configured to define a boundary of a flow path of the gases that interact with the plurality of blades. The platform system may include a plurality of platforms, a first annular coverplate, and a second annular coverplate. The plurality of platforms may be located circumferentially between neighboring blades of the plurality of blades. The first annular coverplate may be engaged with the disk and interlock with the plurality of platforms to block radial and axial movement of the plurality of platforms relative to the disk. The second annular coverplate may be engaged with the disk and interlock with the plurality of platforms to block radial and axial movement of the plurality of platforms relative to the disk. The second annular coverplate may be spaced apart axially from the first annular coverplate.

In some embodiments, the first annular coverplate may include a ring-shaped body and a retainer ring. The ring-shaped body may be arranged circumferentially around the axis. The retainer rail may extend axially from the ring-shaped body and cooperate with the ring-shaped body to define a first coverplate channel that opens radially inwardly. The retainer rail may be formed to define a plurality of first coverplate teeth that extend radially inward toward the axis.

In some embodiments, each of the plurality of platforms may include an outer radial wall that defines the boundary of the flow path, a first skirt, and a second skirt. The first skirt may extend radially inward from the outer radial wall. The second skirt may extend radially inward from the outer radial wall. The first skirt may include a side wall and a hook-shaped lip that extends axially away from the side wall and cooperates with the side wall to define a first skirt channel that opens radially outwardly. The hook-shaped lip may be formed to define a plurality of first skirt teeth that extend radially outward away from the axis.

In some embodiments, the plurality of first coverplate teeth may be located in the first skirt channel and may engage the plurality of first skirt teeth to provide a bayonet fitting. In some embodiments, the first annular coverplate may further include an inner support arm that extends axially away from the ring-shaped body and engages the disk.

In some embodiments, each of the plurality of platforms may include an outer radial wall, a first skirt, and a second skirt. The first skirt may extend radially inward from the outer radial wall. The second skirt may extend radially inward from the outer radial wall. The second skirt may be spaced apart axially from the first skirt to define a passage therebetween and the passage may be sized to receive an outer rim of the disk.

In some embodiments, the first annular coverplate may be formed to include a first wing that extends axially away from the ring-shaped body. The first wing may be adapted to interact with a vane assembly of the gas turbine engine. In some embodiments, the first annular coverplate may engage at least one of the plurality of platforms circumferentially to limit rotation of the first annular coverplate relative to the plurality of platforms about the axis.

According to another aspect of the present disclosure, a wheel assembly for a gas turbine engine may include a disk, a blade, and a platform system. The disk may be formed to define a blade-receiver slot. The blade may be received in the blade-receiver slot of the disk. The platform system may include a plurality of platforms and an annular coverplate that interlocks with one of the disk and the plurality of platforms to block axial movement of the plurality of platforms relative to the disk.

In some embodiments, the annular coverplate may include a ring-shaped body and a retainer rail. The ring-shaped body may be arranged circumferentially around an axis. The retainer rail may extend axially from the ring-shaped body and cooperate with the ring-shaped body to define a coverplate channel that opens radially inwardly. In some embodiments, the retainer rail may be formed to define a plurality of coverplate teeth that extend radially inward toward the axis.

In some embodiments, each of the plurality of platforms may include an outer radial wall, a first skirt, and a second skirt. The first skirt may extend radially inward from the outer radial wall. The second skirt may extend radially inward from the outer radial wall. The first skirt may include a side wall and a hook-shaped lip that extends axially away from the side wall and cooperates with the side wall to define a first skirt channel that opens radially outwardly. The hook-shaped lip may be formed to define a plurality of first skirt teeth that extend radially outward away from the axis. The plurality of coverplate teeth may be located in the first skirt channel and engage the plurality of first skirt teeth to provide a bayonet fitting between the annular coverplate and the first skirt.

In some embodiments, one of the annular coverplate and the first skirt may be formed to include a stop tab that engages the other of the annular coverplate and the first skirt to limit rotation of the annular coverplate relative to the first skirt about the axis. In some embodiments, the annular coverplate may interlock with the plurality of platforms and engage the disk.

In some embodiments, the annular coverplate may be formed to include a first wing that extends axially away from the ring-shaped body. The first wing may be adapted to interact with a vane assembly of the gas turbine engine.

In some embodiments, the disk may be formed to include a body and a plurality of disk teeth that extend radially inward from the body to define a disk channel therebetween. The annular coverplate may include a ring-shaped body that is arranged circumferentially around an axis and a retainer rail that extends axially from the ring-shaped body and cooperates with the ring-shaped body to define a coverplate channel that opens radially outwardly. The retainer rail may be formed to define a plurality of coverplate teeth that extend radially outward toward the axis. The plurality of coverplate teeth may be located in the disk channel and engage the plurality of disk teeth to provide a bayonet fitting between the annular coverplate and the disk.

According to another aspect of the present disclosure, a method may include a number of steps. The method may include providing a wheel assembly that includes a disk, a plurality of blades, and a platform system that includes a plurality of platforms and an annular coverplate, inserting the plurality of blades in the disk so that the plurality of blades are arranged circumferentially about an axis, locating each of the plurality of platforms circumferentially between neighboring blades of the plurality of blades to define a boundary of a flow path for gases with the plurality of platforms, aligning the annular coverplate axially with the plurality of platforms, moving the annular coverplate relative to the plurality of platforms so that a portion of the annular coverplate is received in channels defined by the plurality of platforms, and rotating the annular coverplate relative to the plurality of platforms to interlock the annular coverplate with the plurality of platforms to block axial and radial movement of the plurality of platforms relative to the disk.

In some embodiments, the annular coverplate may include a ring-shaped body that is arranged circumferentially around the axis and a retainer rail that extends axially from the ring-shaped body and cooperates with the ring-shaped body to define a coverplate channel. The retainer rail may be formed to define a plurality of coverplate teeth that extend radially. Each of the plurality of platforms may include an outer radial wall, a first skirt that extends radially inward from the outer radial wall, and a second skirt that extends radially inward from the outer radial wall. The first skirt may include a side wall and a hook-shaped lip that extends axially away from the side wall. The hook-shaped lip may be formed to define a plurality of skirt teeth that extend radially.

In some embodiments, the method may include rotating the annular coverplate relative to the plurality of platforms in a first direction until the annular coverplate is blocked from further rotation in the first direction due to engagement with at least one of the plurality of platforms. In some embodiments, the method may include misaligning circumferentially the plurality of coverplate teeth and the plurality of skirt teeth before the moving step. The moving step may include moving the annular coverplate relative to the plurality of platforms so that the plurality of skirt teeth are located in the coverplate channel and the plurality of coverplate teeth are located in the channels defined by the plurality of platforms. The rotating step may include rotating the annular coverplate relative to the plurality of platforms so that the plurality of coverplate teeth and the plurality of skirt teeth are aligned circumferentially.

These and other features of the present disclosure will become more apparent from the following description of the illustrative embodiments.

### BRIEF DESCRIPTION OF THE DRAWINGS

FIG. 1 is a cutaway view of a gas turbine engine that includes a fan, a compressor, a combustor, and a turbine and the turbine includes a plurality of turbine wheel assemblies in accordance with the present disclosure adapted to extract work from hot combustion products received from the combustor;

FIG. 2 is a front elevation view of a portion of one of the turbine wheel assemblies included in the gas turbine engine of FIG. 1 showing that the turbine wheel assembly includes a disk, a plurality of blades, and a platform system;

FIG. 3 is a diagrammatic and cross-sectional view of the turbine wheel assembly of FIG. 2 taken along line 3-3 showing the platform system includes a plurality of platforms located circumferentially between neighboring blades, a forward annular coverplate interlocked with the platforms, and an aft annular coverplate interlocked with the platforms;

FIG. 4 is an exploded view of a portion of the turbine wheel assembly of FIG. 3 showing the blade includes a dovetail root configured to be arranged in a blade-receiver slot formed in the disk and showing that the platforms of the platform system include a plurality of skirt teeth that engage a plurality of coverplate teeth included in the coverplates to provide a bayonet fitting and block radial and axial movement of the platforms relative to the disk;

FIG. 5 is a view similar to FIG. 3 showing the disk, one of the blades, one of the platforms, the forward annular coverplate, and the aft annular coverplate included in the wheel assembly of FIG. 2;

FIG. 6 is a diagrammatic and detail view of the bayonet fitting of FIG. 5 between the platform and the forward annular coverplate showing the coverplate teeth of the coverplate and the skirt teeth of the platform disengaged to allow the coverplate to be received axially by the platform;

FIG. 7 is a diagrammatic and detail view of the bayonet fitting of FIG. 5 after the forward annular coverplate has been rotated relative to the platform as suggested by the arrow and showing that the coverplate teeth of the coverplate and the skirt teeth of the platform are engaged to block axial and radial movement of the platform relative to the disk;

FIG. 8 is a diagrammatic and cross-sectional view of another embodiment of a turbine wheel assembly adapted for use in the gas turbine engine of FIG. 1 showing that the turbine wheel assembly includes a disk, a plurality of blades, and a platform system that includes a plurality of platforms, a forward annular coverplate, and an aft coverplate wherein the coverplates are formed to include forward and aft wings;

FIG. 9 is an exploded view of a portion of the turbine wheel assembly of FIG. 8 showing the blade includes a dovetail root configured to be received in a blade-receiver slot formed in the disk and showing that the platforms of the platform system include a plurality of skirt teeth that are configured to engage a plurality of coverplate teeth included in the coverplates to provide a bayonet fitting and block radial and axial movement of the platforms relative to the disk;

FIG. 10 is a diagrammatic and cross-sectional view of the turbine wheel assembly of FIG. 8 taken along line A-A showing seals located in a gap between the blade and neighboring platforms;

FIG. 11 is a diagrammatic and cross-sectional view of another embodiment of a turbine wheel assembly adapted for used in the gas turbine engine of FIG. 1 showing that the turbine wheel assembly includes a disk, a plurality of blades, and a platform system that includes a plurality of platforms, a forward annular coverplate, and an aft coverplate and showing the forward and aft coverplates interlock with the disk; and

FIG. 12 is an exploded view of a portion of the turbine wheel assembly of FIG. 11 showing the blades include a dovetail root configured to be received in a blade-receiver slot formed in the disk and showing that the disk includes a plurality of disk teeth that engage a plurality of coverplate teeth included in the coverplates to provide a bayonet fitting that blocks axial movement of the platforms.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

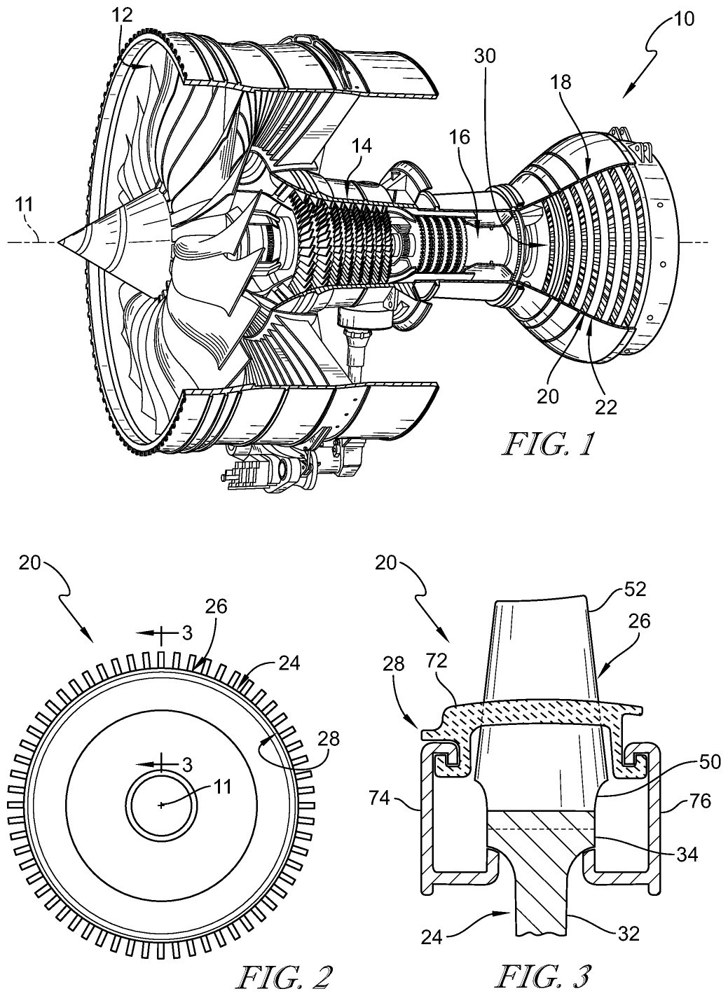

A turbine wheel assembly 20 according to the present disclosure is adapted for use in a gas turbine engine 10 as suggested in FIGS. 1 and 2. The gas turbine engine 10 includes a fan 12, a compressor 14, a combustor 16, and a turbine 18. The fan 12 generates thrust for propelling an aircraft. The compressor 14 compresses and delivers air to the combustor 16. The combustor 16 mixes fuel with the compressed air received from the compressor 14 and ignites the fuel. The hot, high-pressure gases from the burning fuel are directed into the turbine 18 where the turbine 18 extracts work from the gases to drive the compressor 14 and the fan 12. In other embodiments, the gas turbine engine 10 may include a shaft, turboprop, or gearbox in place of the fan 12.

The turbine 18 includes a plurality of turbine wheel assemblies 20 and turbine vane assemblies 22 as shown in FIG. 1. A portion of a turbine wheel assembly 20 is shown in FIG. 2. Each turbine wheel assembly 20 is configured to interact with the hot combustion gases from the combustor 16 and rotate about a center axis 11 of the gas turbine engine 10 to generate power for driving the compressor 14 and/or the fan 12. The turbine vane assembly 22 is located between the turbine wheel assemblies 20 to direct gases received from an upstream turbine wheel assembly 20 toward a downstream turbine wheel assembly 20.

The turbine wheel assembly 20 adapted for use with a gas turbine engine 10 includes a disk 24, a plurality of blades 26, and a platform system 28 as shown in FIGS. 2 and 3. The disk 24 is coupled to a shaft of the gas turbine engine 10 and rotates the shaft about the center axis 11 during operation of the gas turbine engine 10 to generate power. The disk 24 retains the blades 26 during operation of the gas turbine engine 10. The plurality of blades 26 are adapted to interact with and be rotated by the gases that move axially along a gas flow path 30 of the gas turbine engine 10. The platform system 28 is configured to define a boundary of the flow path 30 of the gases that interact with the plurality of blades 26.

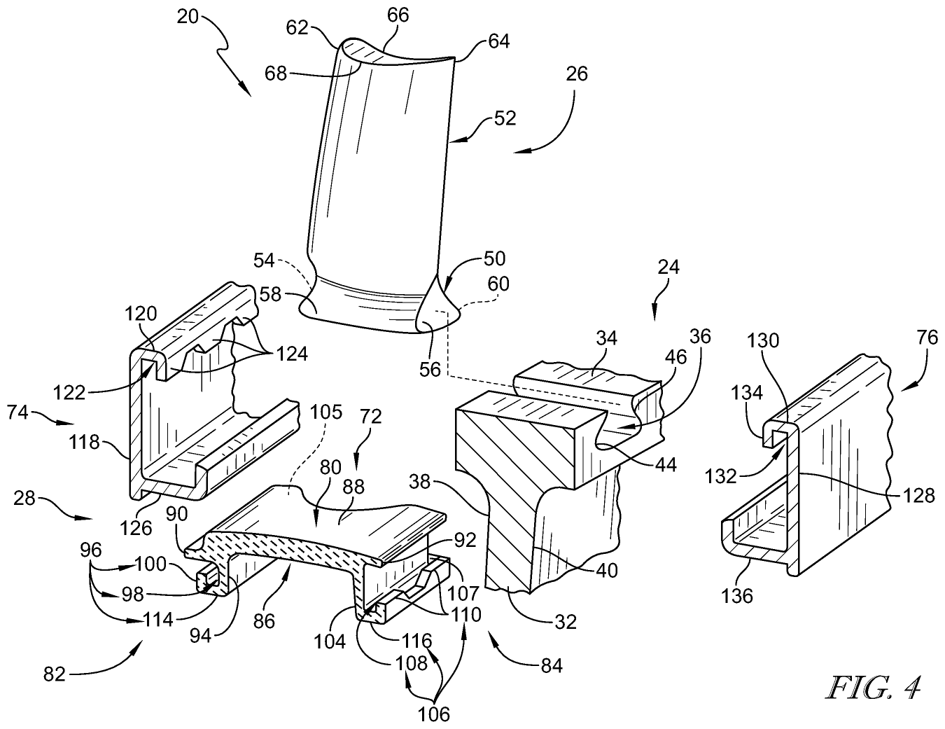

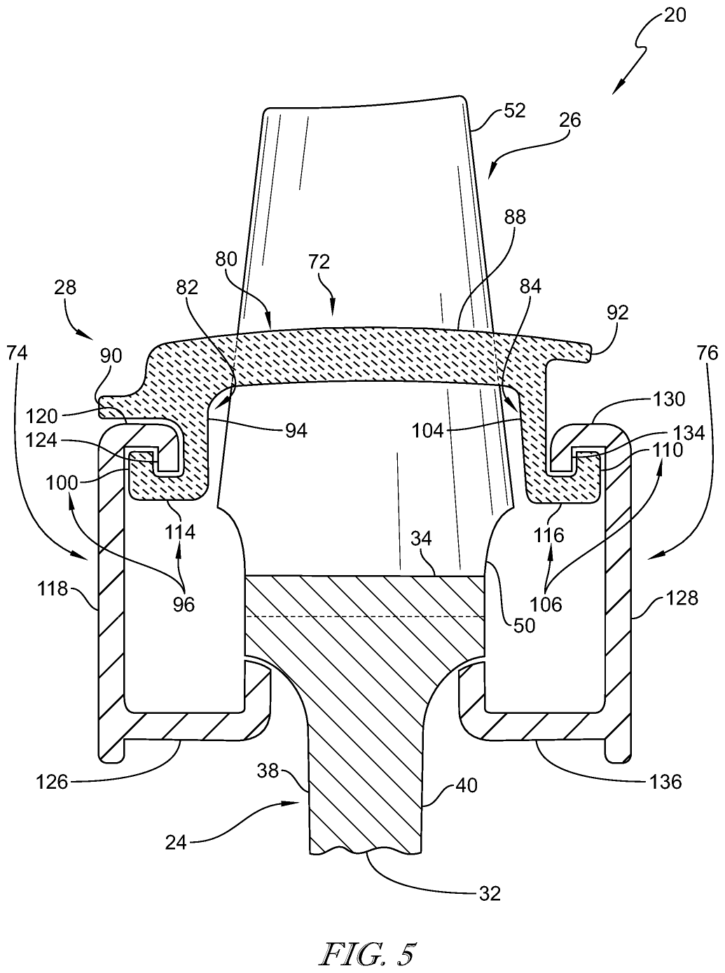

The disk 24 includes a body 32, a rim 34, and a blade-receiver slot 36 defined in the rim 34 as shown in FIGS. 3 and 4. The body 32 is arranged around the center axis 11. The rim 34 extends circumferentially about the body 32. The blade-receiver slot 36 extends axially through the rim 34 and is illustratively dove-tail shaped when viewed axially. In some embodiments, the rim 34 defines a circumferentially extending slot 36. The disk 24 further includes a fore-disk side 38 and an aft-disk side 40 as shown in FIGS. 3 and 5. The aft-disk side 40 is located axially aft of the fore-disk side 38. The blade-receiver slot 36 extends axially through the rim 34 from the fore-disk side 38 to the aft-disk side 40. The rim 34 of the disk 24 is shaped to include a first root engagement surface 44 and a second root engagement surface 46 that engage a root 50 of a blade 26 as shown in FIG. 4.

Each of the plurality of blades 26 includes a root 50 and an airfoil 52 as shown in FIGS. 3 and 4. The airfoil 52 extends radially away from the root 50 relative to the center axis 11. The root 50 of each blade 26 is located in the blade-receiver slot 36 formed in the rim 34 of the disk 24. In the illustrative embodiment, the root 50 is dovetail shaped when view axially. The airfoils 52 are shaped to be pushed circumferentially by the hot gases moving in the flow gas 30 to cause the turbine wheel assembly 20 to rotate about the center axis 11 during operation of the gas turbine engine 10.

The root 50 of each blade 26 includes a fore surface 54, an aft surface 56, a first engagement surface 58, and a second engagement surface 60 as shown in FIG. 4. The first engagement surface 58 engages the first root engagement surface 44 of the blade-receiver slot 36 and the second engagement surface 60 engages the second root engagement surface 46 of the blade-receiver slot 36 to couple each of the blades 26 to the disk 24 and block radial outward movement of the blade 26 away from the disk 24. The airfoil 52 of each blade 26 includes a leading edge 62 and a trailing edge 64 spaced apart axially from the leading edge 62 relative to the center axis 11 as shown in FIG. 4. The airfoil 52 further includes a pressure side 66 and a suction side 68 spaced apart circumferentially from the pressure side 66.

Illustratively, the root 50 and the airfoil 52 of each blade 26 are integrally formed such that each blade 26 is a single, one-piece component. The blades 26 comprise ceramic matrix composite materials in some embodiments. The blade 26 comprises only ceramic matrix composite materials in the illustrative embodiment. In other embodiments, the blades 26 may comprise one or more of ceramic matrix composite materials, composite materials, and metallic materials. The blades 26 are formed as separate components from the platforms 72.

The platform system 28 includes a plurality of platforms 72, a forward annular coverplate 74, and an aft annular coverplate 76 as shown in FIGS. 3 and 4. The plurality of platforms 72 are located circumferentially between neighboring blades 26. The forward annular coverplate 74 engages the disk 24 and is interlocked with the platforms 72 to block radial and forward axial movement of the plurality of platforms 72 relative to the disk 24. The aft annular coverplate 76 engages the disk 24 and is interlocked with the plurality of platforms 72 to block radial and aft axial movement of the plurality of platforms 72 relative to the disk 24.

Each of the plurality of platforms 72 include an outer radial wall 80, a forward skirt 82, and an aft skirt 84 as shown in FIGS. 3-5. The outer radial wall 80 is arranged partway around the blade 26 and defines the boundary of the flow path 30 of the gases. The forward skirt 82 extends radially inward from the outer radial wall 80. The aft skirt 84 extends radially inward from the outer radial wall 80 and is spaced apart axially from the forward skirt 82 to define a passage 86 therebetween. The passage 86 is sized to receive the outer rim 34 of the disk 24.

The outer radial wall 80 of the platform 72 includes a panel 88, a fore wing 90, and an aft wing 92 as shown in FIGS. 3-5. The panel 88 is configured to be arranged partway around the blades 26. The fore wing 90 extends axially forward away from the panel 88 toward a front of the fore-disk side 38 of the disk 24. The aft wing 92 extends axially aft away from the panel 88 toward a rear of the aft-disk side 40 of the disk 24. The fore wing 90 and the aft wing 92 may engage portions of the turbine vane assemblies 22 located fore and aft of the turbine wheel assembly 20.

The forward skirt 82 includes a side wall 94 and a hook-shaped lip 96 as shown in FIGS. 3-5. The hook-shaped lip 96 extends axially forward away from the side wall 94 and cooperates with the side wall 94 to define a forward skirt channel 98. The forward skirt channel 98 opens radially outwardly. The hook-shaped lip 96 is formed to include an inner radial wall 114 and to define a plurality of forward skirt teeth 100 that extend radially outward away from the inner radial wall 114. The hook-shaped lip 96 is formed to include a stop tab 105 in some embodiments that engage the forward coverplate 74 to limit how far the coverplate 74 may rotate. In some embodiments, the coverplate 74 is formed to include a stop tab.

The aft skirt 84 includes a side wall 104 and a hook-shaped lip 106 as shown in FIGS. 3-5. The hook-shaped lip 106 extends axially aft away from the side wall 104 and cooperates with the side wall 104 to define an aft skirt channel 108. The aft skirt channel 108 opens radially outwardly. The hook-shaped lip 106 is formed to include an inner radial wall 116 and to define a plurality of aft skirt teeth 110 that extend radially outward away from the axis 11. The hook-shaped lip 106 is formed to include a stop tab 107 in some embodiments that engage the aft coverplate 76 to limit how far the coverplate 76 may rotate. In some embodiments, the coverplate 76 is formed to include a stop tab.

In illustrative embodiments, the platforms 72 are separate components from the blades 26 and are incorporated as an offloaded part. As a result, the roots 50 of the blades 26 may not support the centrifugal load associated with the platforms 72. The platforms 72 comprise ceramic matrix composite materials in the illustrative embodiment. In other embodiments, the blades 26 and/or the platforms 72 comprise metallic, monolithic ceramic, or composite materials.

The forward annular coverplate 74 includes a ring-shaped body 118 and a retainer rail 120 as shown in FIGS. 3-5. The ring-shaped body 118 is arranged circumferentially around the axis 11. The retainer rail 120 extends axially aft from the ring-shaped body 118 to define a forward coverplate channel 122 that opens radially inwardly. The retainer rail 120 is formed to define a plurality of forward coverplate teeth 124 that extend radially inward toward the axis 11. The forward coverplate teeth 124 are located in the forward skirt channel 98 and engage the plurality of forward skirt teeth 100 to provide a bayonet fitting as suggested in FIGS. 5-7. In the illustrative embodiment, the forward annular coverplate 74 further includes an inner support arm 126 as shown in FIGS. 4 and 5. The inner support arm 126 extends axially aft away from the ring-shaped body 118 and engages the fore-disk side 38 of the disk 24.

The aft annular coverplate 76 includes a ring-shaped body 128 and a retainer rail 130 as shown in FIGS. 3-5. The ring-shaped body 128 is arranged circumferentially around the axis 11. The retainer rail 130 extends axially forward from the ring-shaped body 128 to define an aft coverplate channel 132 that opens radially inwardly. The retainer rail 130 is formed to define a plurality of aft coverplate teeth 134 that extend radially inward toward the axis 11. The aft coverplate teeth 134 are located in the aft skirt channel 108 and engage the plurality of aft skirt teeth 110 to provide a bayonet fitting. In the illustrative embodiment, the aft annular coverplate 76 further includes an inner support arm 136 as shown in FIGS. 4 and 5. The inner support arm 136 extends axially forward away from the ring-shaped body 128 and engages the aft-disk side 40 of the disk 24.

A method of assembling the turbine wheel assembly 20 may include a number of steps. The method includes providing the wheel assembly 20 that includes the disk 24, the plurality of blades 26, and the platform system 28. The method includes inserting the plurality of blades 26 in the disk 24 so that the blades 26 are arranged circumferentially about the axis 11. Each of the plurality of platforms 72 is located circumferentially between the neighboring blades 26 to define the boundary of the flow path 30 for gasses with the plurality of platforms 72.

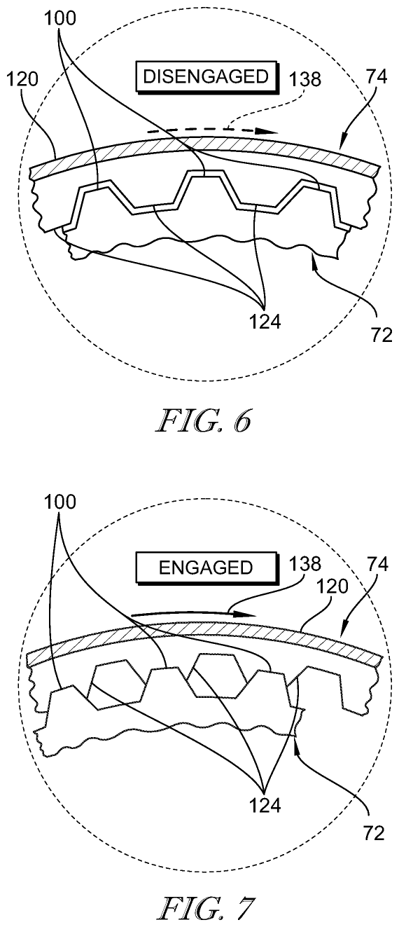

The method includes aligning the annular coverplate 74, 76 axially with the plurality of platforms 72 and moving the annular coverplate 74, 76 relative to the platforms 72 so that a portion of the annular coverplate 74, 76 is received in channels 98, 108 defined by the plurality of platforms 72 as suggested in FIG. 6. The annular coverplate 74, 76 is rotated relative to the plurality of platforms 72 to interlock the annular coverplate 74, 76 with the platforms 72 to block axial and radial movement of the platforms 72 relative to the disk 24. In the illustrative embodiment, the annular coverplate 74, 76 is rotated relative to the platforms 72 in a first direction until the annular coverplate 74, 76 is blocked from further rotation in the first direction due to engagement with at least one of the plurality of platforms 72. The first direction is suggested by arrow 138 in FIGS. 6 and 7.

In some embodiments, the method further includes misaligning circumferentially the plurality of coverplate teeth 124, 134 and the plurality of skirt teeth 100, 110 before the moving step as shown in FIG. 6. The moving step may include moving the annular coverplate 74, 76 relative to the plurality of platforms 72 so that the skirt teeth 100, 110 are located in the coverplate channel 122, 132 and the coverplate teeth 124, 134 are located in the channels 98, 108 defined by the plurality of platforms 72. The rotating step may include rotating the annular coverplate 74, 76 relative to the plurality of platforms 72 so that the cover plate teeth 124, 134 and the skirt teeth 110, 110 are aligned circumferentially as shown in FIG. 7.

Another embodiment of a turbine wheel assembly 220 in accordance with the present disclosure is shown in FIGS. 8-10. The turbine wheel assembly 220 is substantially similar to the turbine wheel assembly 20 shown in FIGS. 1-7 and described herein. Accordingly, similar reference numbers in the 200 series indicate features that are common between the turbine wheel assembly 20 and the turbine wheel assembly 220. The description of the turbine wheel assembly 20 is incorporated by reference to apply to the turbine wheel assembly 220, except in instances when it conflicts with the specific description and the drawings of the turbine wheel assembly 220.

The turbine wheel assembly 220 includes a disk 224, a plurality of blades 226, and a platform system 228 as shown in FIGS. 8-10. The disk 224 is coupled to a shaft of the gas turbine engine 10 and rotates the shaft about the center axis 11 during operation of the gas turbine engine 10 to generate power. The disk 224 is also adapted to retain the blades 226 during operation of the gas turbine engine 10. The plurality of blades 226 are adapted to interact with and be rotated by the gases that move axially along a gas flow path 30 of the gas turbine engine 10 during used of the gas turbine engine 10. The platform system 228 is configured to define a boundary of the flow path 30 of the gases that interact with the plurality of blades 226.

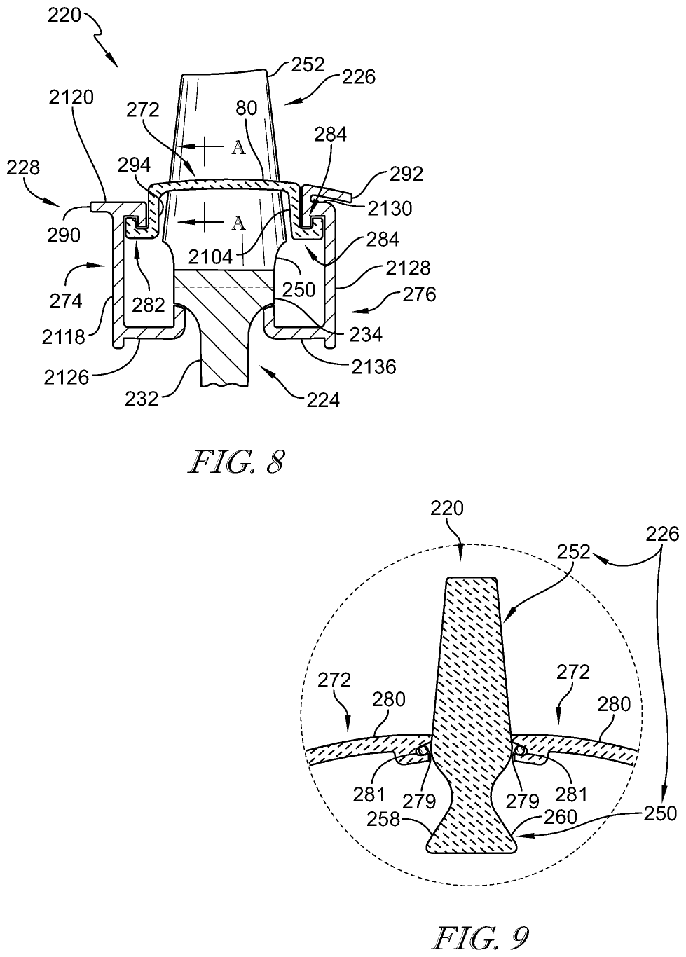

The disk 224 includes a body 232, a rim 234, and a blade-receiver slot 236 as shown in FIGS. 8 and 9. The body 232 is arranged around the center axis 11. The rim 234 extends circumferentially about the body 232. The blade-receiver slot 236 extends axially through the rim 234 and is illustratively dove-tail shaped when viewed axially. The disk 224 further includes a fore-disk side 238 and an aft-disk side 240 as shown in FIGS. 8 and 9. The aft-disk side 240 is located axially aft of the fore-disk side 238. The blade-receiver slot 236 extends axially through the rim 234 from the fore-disk side 238 to the aft-disk side 240. Each blade-receiver slot 236 formed in the rim 234 of the disk 224 includes a first root engagement surface 244 and a second root engagement surface 246 as shown in FIG. 9.

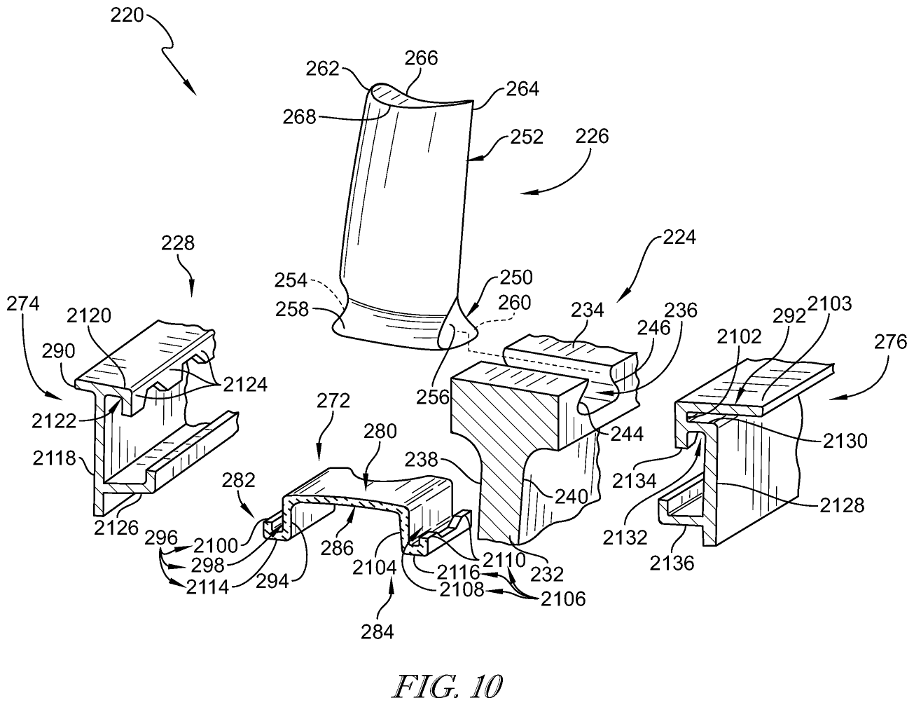

Each of the plurality of blades 226 includes a root 250 located in one of the blade-receiver slots 236 and an airfoil 252 as shown in FIGS. 8-10. The root 250 of each blade 226 includes a fore surface 254, an aft surface 256, a first engagement surface 258, and a second engagement surface 260 as shown in FIGS. 9 and 10. The airfoil 252 of each blade 226 includes a leading edge 262, a trailing edge 264 spaced apart axially from the leading edge 262, a pressure side 266, and a suction side 268 spaced apart circumferentially from the pressure side 266.

Illustratively, the root 250 and the airfoil 252 of each blade 226 are integrally formed such that each blade 226 is a one-piece integral component. The blades 226 comprise ceramic matrix composite materials in some embodiments. The blade 226 comprises only ceramic matrix composite materials in the illustrative embodiment. In other embodiments, the blades 226 may comprise one or more of ceramic matrix composite materials, composite materials, and metallic materials.

The platform system 228 includes a plurality of platforms 272, a forward annular coverplate 274, and an aft annular coverplate 276 as shown in FIGS. 8 and 9. The plurality of platforms 272 are located circumferentially between neighboring blades 226. The forward annular coverplate 274 engages the disk 224 and is interlocked with the platforms 272 to block radial and forward axial movement of the plurality of platforms 272 relative to the disk 224. The aft annular coverplate 276 engages the disk 224 and is interlocked with the plurality of platforms 272 to block radial and aft axial movement of the plurality of platforms 272 relative to the disk 224.

Each of the plurality of platforms 272 include an outer radial wall 280, a forward skirt 282, and an aft skirt 284 as shown in FIGS. 8-10. The outer radial wall 280 is arranged partway around the blade 226 and defines the boundary of the flow path 30 of the gases. The forward skirt 282 extends radially inward from the outer radial wall 280. The aft skirt 284 extends radially inward from the outer radial wall 280 and is spaced apart axially from the forward skirt 282 to define a passage 286 therebetween. The passage 286 is sized to receive the outer rim 234 of the disk 224.

The forward skirt 282 includes a side wall 294 and a hook-shaped lip 296 as shown in FIGS. 8 and 9. The hook-shaped lip 296 extends axially forward away from the side wall 294 and cooperates with the side wall 294 to define a forward skirt channel 298. The forward skirt channel 298 opens radially outwardly. The hook-shaped lip 296 includes an inner radial wall 2114 and a plurality of forward skirt teeth 2100 that extend radially outward away from the inner radial wall 2114.

The aft skirt 284 includes a side wall 2104 and a hook-shaped lip 2106 as shown in FIGS. 8 and 9. The hook-shaped lip 2106 extends axially aft away from the side wall 2104 and cooperates with the side wall 2104 to define an aft skirt channel 2108. The aft skirt channel 2108 opens radially outwardly. The hook-shaped lip 2106 includes an inner radial wall 2116 and a plurality of aft skirt teeth 2110 that extend radially outward away from the inner radial wall 2116. In some embodiments, the skirts 282, 284 are formed to include stop tabs that engage the forward and aft annular coverplates 274, 276 to bock rotation of the coverplates 274, 276 relative to the disk 224.

In illustrative embodiments, the platforms 272 are separate components from the blades 226 and are incorporated as an offloaded part. As a result, the roots 250 of the blades 226 may not support the centrifugal load associated with the platforms 272. The platforms 272 comprise ceramic matrix composite materials in the illustrative embodiment. In other embodiments, the blades 226 and/or the platforms 272 comprise metallic, monolithic ceramic, or composite materials.

In some embodiments, the platforms 272 further include seals 279 and seal-receiver channels 281 as shown in FIG. 10. The seal-receiver channels are arranged to axially extend through a side of the outer radial wall 280 interfacing the blade 226. The seals 279 are located in the seal-receiver channels 281 and are configured to seal a gap between the outer radial walls 280 of the platforms 272. The seal 279 may be one of a damper seal, a wire seal, and any other suitable seal type.

The forward annular coverplate 274 includes a forward wing 290, a ring-shaped body 2118, and retainer rail 2120 as shown in FIGS. 8 and 9. The forward wing 290 extends axially forward away from the ring-shaped body 2118 and is adapted to interact with the vane assemblies 22 of the gas turbine engine 10. The ring-shaped body 2118 is arranged circumferentially around the axis 11. The retainer rail 2120 extends axially aft from the ring-shaped body 2118 to define a forward coverplate channel 2122. The forward coverplate channel 2122 opens radially inwardly. The retainer rail 2120 is formed to define a plurality of forward coverplate teeth 2124 that extend radially inward toward the axis 11. The forward coverplate teeth 2124 are located in the forward skirt channel 298 and engage the plurality of forward skirt teeth 2100 to provide a bayonet fitting.

The aft annular coverplate 276 includes an aft wing 292, a ring-shaped body 2128, and a retainer rail 2130 as shown in FIGS. 8 and 9. The aft wing 292 extends axially aft away from the retainer rail 2130 and is adapted to interact with the vane assemblies 22 of the gas turbine engine 10. The ring-shaped body 2128 is arranged circumferentially around the axis 11. The retainer rail 2130 extends axially forward from the ring-shaped body 2128 to define an aft coverplate channel 2132. The aft coverplate channel 2132 opens radially inwardly. The retainer rail 2130 is formed to define a plurality of aft coverplate teeth 2134 that extend radially inward toward the axis 11. The aft coverplate teeth 2134 are located in the aft skirt channel 2108 and engage the plurality of aft skirt teeth 2110 to provide a bayonet fitting.

In the illustrative embodiment, the aft wing 292 includes a post 2102 and an outer aft wing plate 2103 as shown in FIG. 9. The post 2102 extends radially inward from the outer aft wing plate 2013 and couples the outer aft wing plate 2103 to the retainer rail 2130. The outer aft wing plate 2103 extends axially aft away from the retainer rail 2130 and the ring-shaped body 2128 and interacts with the vane assemblies 22 of the gas turbine engine 10.

In the illustrative embodiment, the forward annular coverplate 274 further includes an inner support arm 2126 and the aft annular coverplate 276 further includes an inner support arm 2136 as shown in FIGS. 8 and 9. The inner support arm 2126 extends axially aft away from the ring-shaped body 2118 and engages the fore-disk side 238 of the disk 224. The inner support arm 2136 extends axially forward away from the ring-shaped body 2128 and engages the aft-disk side 240 of the disk 224.

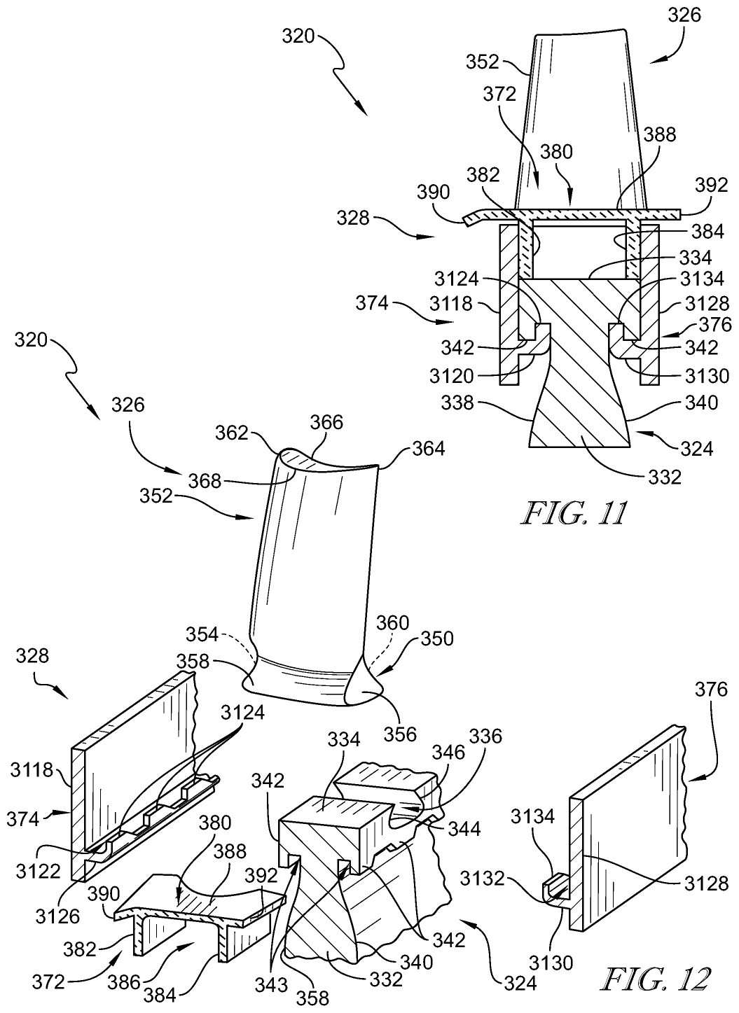

Another embodiment of a turbine wheel assembly 320 in accordance with the present disclosure is shown in FIGS. 11 and 12. The turbine wheel assembly 320 is substantially similar to the turbine wheel assembly 20 shown in FIGS. 1-7 and described herein. Accordingly, similar reference numbers in the 300 series indicate features that are common between the turbine wheel assembly 20 and the turbine wheel assembly 320. The description of the turbine wheel assembly 20 is incorporated by reference to apply to the turbine wheel assembly 320, except in instances when it conflicts with the specific description and the drawings of the turbine wheel assembly 320.

The turbine wheel assembly 320 includes a disk 324, a plurality of blades 326, and a platform system 328 as shown in FIGS. 11 and 12. The disk 324 is adapted to retain the blades 326 during operation of the gas turbine engine 10. The platform system 328 is configured to define a boundary of the flow path 30 of the gases that interact with the plurality of blades 326.

The disk 324 includes a body 332, a rim 334, and a blade-receiver slot 336 as shown in FIGS. 11 and 12. The blade-receiver slot 336 extends axially through the rim 334 and is illustratively dove-tail shaped when viewed axially. The rim 334 includes a first root engagement surface 344 and a second root engagement surface 346 as shown in FIG. 12. The disk 324 further includes a fore-disk side 338, an aft-disk side 340, and a plurality of disk teeth 342 as shown in FIGS. 11 and 12. The aft-disk side 340 is located axially aft of the fore-disk side 338. The disk teeth 342 extend radially inward from the rim 334 on both the fore-disk side 338 and the aft-disk side 340 to define a disk channel 343 on either side 338, 340.

Each of the plurality of blades 326 includes a root 350 and an airfoil 352 as shown in FIGS. 11 and 12. The root 350 of each blade 326 includes a fore surface 354, an aft surface 356, a first engagement surface 358, and a second engagement surface 360 as shown in FIGS. 11 and 12. The first engagement surface 358 engages the first root engagement surface 344 of the blade-receiver slot 336 and the second engagement surface 360 engages the second root engagement surface 346 of the blade-receiver slot 336 to couple each of the blades 326 to the disk 324 and block radial outward movement of each blade 326 away from the disk 324. The airfoil 352 of each blade 326 includes a leading edge 362 and a trailing edge 364, a pressure side 366, and a suction side 268. The pressure side 366 and the suction side 368 extend axially between and interconnect the leading edge 362 and the trailing edge 364 of the airfoil 352.

Illustratively, the root 350 and the airfoil 352 of each blade 326 are integrally formed such that each blade 326 is a one-piece integral component. The blades 326 comprise ceramic matrix composite materials in some embodiments. The blade 326 comprises only ceramic matrix composite materials in the illustrative embodiment. In other embodiments, the blades 326 may comprise one or more of ceramic matrix composite materials, composite materials, and metallic materials.

The platform system 328 includes a plurality of platforms 372, a forward annular coverplate 374, and an aft annular coverplate 376 as shown in FIGS. 11 and 12. The plurality of platforms 372 are located circumferentially between neighboring blades 326. The forward annular coverplate 374 engages the fore-disk side 338 of the disk 324 and interlocks with one of the disk 324 and the plurality of platforms 372 to block axial movement of the plurality of platforms 372 relative to the disk 324. The aft annular coverplate 276 engages the aft-disk side 340 of the disk 324 interlocks with one of the disk 324 and the plurality of platforms 372 to block axial movement of the plurality of platforms 372 relative to the disk 324.

Each of the plurality of platforms 372 include an outer radial wall 380, a first skirt 382, and a second skirt 384 as shown in FIGS. 11 and 12. The outer radial wall 380 is arranged partway around the blade 326 and defines the boundary of the flow path 30 of the gases. The first skirt 382 extends radially inward from the outer radial wall 380. The second skirt 384 extends radially inward from the outer radial wall 380 and is spaced apart axially from the forward skirt 382 to define a passage 386 therebetween. The passage 386 is sized to receive the outer rim 334 of the disk 324.

The outer radial wall 380 includes a panel 388, a fore wing 390, and an aft wing 392 as shown in FIGS. 11 and 12. The panel 388 is configured to be arranged partway around the blades 326. The fore wing 390 extends axially forward away from the panel 388 toward a front of the fore-disk side 338 of the disk 324. The aft wing 392 extends axially aft away from the panel 388 toward a rear of the aft-disk side 340 of the disk 324. The fore wing 390 and the aft wing 392 may engage portions of the turbine vane assemblies 22 located fore and aft of the turbine wheel assembly 320. In other embodiments, the coverplates 374, 376 are formed to include the wings 390, 392.

In illustrative embodiments, the platforms 372 are separate components from the blades 326 and are incorporated as an offloaded part. As a result, the roots 350 of the blades 326 may not support the centrifugal load associated with the platforms 372. The platforms 372 comprise ceramic matrix composite materials in the illustrative embodiment. In other embodiments, the blades 326 and/or the platforms 372 comprise metallic, monolithic ceramic, or composite materials.

The forward annular coverplate 374 includes a ring-shaped body 3118 and a retainer rail 3120 as shown in FIGS. 11 and 12. The ring-shaped body 3118 is arranged circumferentially around the axis 11. The retainer rail 3120 extends axially aft from the ring-shaped body 3118 to define a forward coverplate channel 3122 that opens radially outwardly. The retainer rail 3120 is formed to define a plurality of forward coverplate teeth 3124 that extend radially outward away from the axis 11. The forward coverplate teeth 2124 are located in the disk channel 343 on the fore-disk side 338 of the disk 324 and engage the plurality of disk teeth 342 to provide a bayonet fitting.

The aft annular coverplate 376 includes a ring-shaped body 3128 and a retainer rail 3130 as shown in FIGS. 11 and 12. The ring-shaped body 3128 is arranged circumferentially around the axis 11. The retainer rail 3130 extends axially forward from the ring-shaped body 3128 to define an aft coverplate channel 3132 that opens radially outwardly. The retainer rail 3130 is formed to define a plurality of aft coverplate teeth 3134 that extend radially outwardly away from the axis 11. The aft coverplate teeth 3134 are located in the disk channel 343 on the aft-disk side 340 of the disk 324 and engage the plurality of disk teeth 342 to provide a bayonet fitting.

In an attempt to improve turbine efficiency, combustor outlet temperatures may continue to rise to improve cycle efficiency and power density in gas turbine engines. Incorporation of ceramic matrix composite components into the turbine section may offer the potential of reducing cooling air due to the higher temperature capability and reducing engine weight of ceramic matrix composite components relative to metallic components due to their low density.

Due to possible difficulties in manufacturing ceramic matrix composite blades and the relatively low strength of the material, it may be desirable to off load the platform from each blade to minimize both the centrifugal pull on the blade attachment and the difficulty in manufacturing the blade. Retention and locating the platform with respect to the blade and disk may be difficult with off loaded platforms.

The present disclosure provides means for retaining the platform by using a bayonet fitting on the front and aft skirts of the platforms to interface with forward and aft coverplates. In some embodiments, the platform is a separate piece from the blade and made from a metallic turbine alloy such as CMSX-3/4 or Mar-M247 or from a ceramic matrix composite material or Monolithic ceramic. The platform fits between two airfoils and would form the inner flowpath including forward and aft angel wings in some embodiments. A forward and aft skirt protrude radially inward from the flowpath such that the skirts fit around the disk posts that are holding the ceramic matrix composite blades. These skirts have a feature that allow for a bayonet fitting which mate with similar features on the forward and aft coverplates. The coverplates are rotated a portion of a revolution in order to engage the bayonet fitting. In other embodiments, the platforms are integral with the blades.

In other embodiments, the angel wings are part of the coverplates as shown in FIGS. 8-10. In other embodiments, a bayonet fitting is located on both the disk and the endwall as shown in FIGS. 11 and 12. This allows the disk to provide the positive retention of the coverplate as opposed to the endwall retaining the coverplate.

To facilitate anti-rotation, a bumpstop on the pilot face and a corresponding key in the coverplate is included such that when the cover plate is rotated into place, it would have a positive stop in one direction. In some embodiments, a damper is fitted between the platform and the airfoil on the pressure side, suction side, or both. The damper is sized to minimize blade excitation and may act as an air seal as well.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A wheel assembly for a gas turbine engine, the wheel assembly comprising
a disk adapted to rotate about an axis during use of the gas turbine engine,
a plurality of blades adapted to interact with gases during use of the gas turbine engine, each of the plurality of blades include a root coupled with the disk for rotation therewith and an airfoil that extends radially away from the root, and
a platform system configured to define a boundary of a flow path of the gases that interact with the plurality of blades, the platform system including a plurality of platforms located circumferentially between neighboring blades of the plurality of blades, a first annular coverplate engaged with the disk and interlocked with the plurality of platforms to block radial and axial movement of the plurality of platforms relative to the disk, and a second annular coverplate engaged with the disk and interlocked with the plurality of platforms to block radial and axial movement of the plurality of platforms relative to the disk, the second annular coverplate spaced apart axially from the first annular coverplate.

2. The wheel assembly of claim 1, wherein the first annular coverplate includes a ring-shaped body that is arranged circumferentially around the axis and a retainer rail that extends axially from the ring-shaped body and cooperates with the ring-shaped body to define a first coverplate channel that opens radially inwardly and the retainer rail is formed to define a plurality of first coverplate teeth that extend radially inward toward the axis.

3. The wheel assembly of claim 2, wherein each of the plurality of platforms includes an outer radial wall that defines the boundary of the flow path, a first skirt that extends radially inward from the outer radial wall, and a second skirt that extends radially inward from the outer radial wall, the first skirt includes a side wall and a hook-shaped lip that extends axially away from the side wall and cooperates with the side wall to define a first skirt channel that opens radially outwardly, and the hook-shaped lip is formed to define a plurality of first skirt teeth that extend radially outward away from the axis.

4. The wheel assembly of claim 3, wherein the plurality of first coverplate teeth are located in the first skirt channel and engage the plurality of first skirt teeth to provide a bayonet fitting.

5. The wheel assembly of claim 3, wherein the first annular coverplate further includes an inner support arm that extends axially away from the ring-shaped body and engages the disk.

6. The wheel assembly of claim 1, wherein each of the plurality of platforms includes an outer radial wall, a first skirt that extends radially inward from the outer radial wall, and a second skirt that extends radially inward from the outer radial wall, and the second skirt is spaced apart axially from the first skirt to define a passage therebetween and the passage is sized to receive an outer rim of the disk.

7. The wheel assembly of claim 2, wherein the first annular coverplate is formed to include a first wing that extends axially away from the ring-shaped body and is adapted to interact with a vane assembly of the gas turbine engine.

8. The wheel assembly of claim 2, wherein the first annular coverplate engage at least one of the plurality of platforms circumferentially to limit rotation of the first annular coverplate relative to the plurality of platforms about the axis.

9. A wheel assembly for a gas turbine engine, the wheel assembly comprising
a disk formed to define a blade-receiver slot,
a blade received in the blade-receiver slot of the disk, and
a platform system that includes a plurality of platforms and an annular coverplate that interlocks with one of the disk and the plurality of platforms to block axial movement of the plurality of platforms relative to the disk.

10. The wheel assembly of claim 9, wherein the annular coverplate interlocks with the plurality of platforms and engages the disk.

11. The wheel assembly of claim 10, wherein the annular coverplate includes a ring-shaped body that is arranged circumferentially around an axis and a retainer rail that extends axially from the ring-shaped body and cooperates with the ring-shaped body to define a coverplate channel that opens radially inwardly.

12. The wheel assembly of claim 11, wherein the retainer rail is formed to define a plurality of coverplate teeth that extends radially inward toward the axis.

13. The wheel assembly of claim 12, wherein each of the plurality of platforms includes an outer radial wall, a first skirt that extends radially inward from the outer radial wall, and a second skirt that extends radially inward from the outer radial wall, the first skirt includes a side wall and a hook-shaped lip that extends axially away from the side wall and cooperates with the side wall to define a first skirt channel that opens radially outwardly, the hook-shaped lip is formed to define a plurality of first skirt teeth that extend radially outward away from the axis, and the plurality of coverplate teeth are located in the first skirt channel and engage the plurality of first skirt teeth to provide a bayonet fitting between the annular coverplate and the first skirt.

14. The wheel assembly of claim 13, wherein one of the annular coverplate and the first skirt are formed to include a stop tab that engages the other of the annular coverplate and the first skirt to limit rotation of the annular coverplate relative to the first skirt about the axis.

15. The wheel assembly of claim 11, wherein the annular coverplate is formed to include a first wing that extends axially away from the ring-shaped body and is adapted to interact with a vane assembly of the gas turbine engine.

16. The wheel assembly of claim 9, wherein the disk is formed to include a body and a plurality of disk teeth that extend radially inward from the body to define a disk channel therebetween, the annular coverplate includes a ring-shaped body that is arranged circumferentially around an axis and a retainer rail that extends axially from the ring-shaped body and cooperates with the ring-shaped body to define a coverplate channel that opens radially outwardly, the retainer rail is formed to define a plurality of coverplate teeth that extend radially outward toward the axis, and the plurality of coverplate teeth are located in the disk channel and engage the plurality of disk teeth to provide a bayonet fitting between the annular coverplate and the disk.

17. A method comprising
providing a wheel assembly that includes a disk, a plurality of blades, and a platform system that includes a plurality of platforms and an annular coverplate,
inserting the plurality of blades in the disk so that the plurality of blades are arranged circumferentially about an axis,
locating each of the plurality of platforms circumferentially between neighboring blades of the plurality of blades to define a boundary of a flow path for gases with the plurality of platforms,
aligning the annular coverplate axially with the plurality of platforms,
moving the annular coverplate relative to the plurality of platforms so that a portion of the annular coverplate is received in channels defined by the plurality of platforms, and
rotating the annular coverplate relative to the plurality of platforms to interlock the annular coverplate with the plurality of platforms to block axial and radial movement of the plurality of platforms relative to the disk.

18. The method of claim 17, further including rotating the annular coverplate relative to the plurality of platforms in a first direction until the annular coverplate is blocked from further rotation in the first direction due to engagement with at least one of the plurality of platforms.

19. The method of claim 17, wherein the annular coverplate includes a ring-shaped body that is arranged circumferentially around the axis and a retainer rail that extends axially from the ring-shaped body and cooperates with the ring-shaped body to define a coverplate channel, the retainer rail is formed to define a plurality of coverplate teeth that extend radially, each of the plurality of platforms includes an outer radial wall, a first skirt that extends radially inward from the outer radial wall, and a second skirt that extends radially inward from the outer radial wall, the first skirt includes a side wall and a hook-shaped lip that extends axially away from the side wall, and the hook-shaped lip is formed to define a plurality of skirt teeth that extend radially.

20. The method of claim 19, wherein the method further includes misaligning circumferentially the plurality of coverplate teeth and the plurality of skirt teeth before the moving step, the moving step includes moving the annular coverplate relative to the plurality of platforms so that the plurality of skirt teeth are located in the coverplate channel and the plurality of coverplate teeth are located in the channels defined by the plurality of platforms, and the rotating step includes rotating the annular coverplate relative to the plurality of platforms so that the plurality of coverplate teeth and the plurality of skirt teeth are aligned circumferentially.
